(19) United States
(12) Patent Application Publication
(10) Pub. No.: US 2024/0018396 A1
(43) Pub. Date: Jan. 18, 2024

(54) LOW TEMPERATURE ACTIVATED RELEASE COATING AND A METHOD OF MAKING

(71) Applicant: 3M INNOVATIVE PROPERTIES COMPANY, St. Paul, MN (US)

(72) Inventors: Rohit Gupta, St. Paul, MN (US); James P. DiZio, St. Paul, MN (US); Phillip H. Henna, Cottage Grove, MN (US); Mark C. Lavigne, Greenville, SC (US); Maria O. Miranda, Minneapolis, MN (US); Scott M. Tapio, Falcon Heights, MN (US)

(21) Appl. No.: 18/251,448

(22) PCT Filed: Nov. 11, 2021
(86) PCT No.: PCT/IB2021/060457

§ 371 Date: May 2, 2023

Related U.S. Application Data
(60) Provisional application No. 63/124,157, filed on Dec. 11, 2020.

(51) Int. Cl. C09J 7/40; C08F 220/18; C08L 83/06

(52) U.S. Cl. CPC C09J 7/401; C08F 220/1802; C08L 83/06; C09J 2483/005

(57) ABSTRACT

Described herein is a release coating comprising a blend of: (a) a first polymer, wherein the first polymer is a silicone-containing (meth)acrylic polymer; and (b) a second polymer, wherein the second polymer comprises the polymerization reaction product of: (i) a first monomer having an alkyl group with 12 to 24 carbon atoms, a linking group containing a nitrogen or ester group, and a free-radically polymerizable (meth)acryl group; and (ii) a second free-radically polymerizable monomer having less than 12 carbon atoms. Such release coatings can be coated onto a substrate and used as a release coating for pressure sensitive adhesives.

### TECHNICAL FIELD

A release coating and articles thereof are discussed wherein the release coating can be dried and/or activated at lower temperatures. A method of making said release coated article is also disclosed.

### SUMMARY

There is a desire to identify release coatings that can be coated and then dried and/or activated at lower temperatures, while still providing good release properties.

In one aspect, a release-coated substrate is described. The release-coated substrate comprising:
a release layer disposed on a substrate, the release layer comprising a blend of:
(a) a first polymer, wherein the first polymer is a silicone-containing (meth)acrylic polymer; and
(b) a second polymer, wherein the second polymer comprises the polymerization reaction product of:
   (i) a first monomer having an alkyl group with 12 to 24 carbon atoms, a linking group containing a nitrogen or ester group, and a free-radically polymerizable (meth)acryl group; and
   (ii) a second free-radically polymerizable monomer having less than 12 carbon atoms.

In another aspect, a release-coating is described. The release-coating comprising:
a release layer disposed on a substrate, the release layer comprising a blend of:
(a) a first polymer, wherein the first polymer is a silicone-containing (meth)acrylic polymer; and
(b) a second polymer, wherein the second polymer comprises the polymerization reaction product of:
   (i) a first monomer having an alkyl group with 12 to 24 carbon atoms, a linking group containing a nitrogen or ester group, and a free-radically polymerizable (meth)acryl group; and
   (ii) a second free-radically polymerizable monomer having less than 12 carbon atoms.

In yet another aspect, a method for making a release-coated article is described. The method comprising:
providing a blend, the blend comprising a water borne first polymer, wherein the water borne first polymer is a silicone-containing (meth)acrylic polymer; and a water borne second polymer, wherein the water borne second polymer comprises the polymerization reaction product of:
   (i) a first monomer having an alkyl group with 12 to 24 carbon atoms, a linking group containing a nitrogen or ester group, and a free-radically polymerizable (meth)acryl group;
   (ii) a second free-radically polymerizable monomer having less than 12 carbon atoms; and
   (iii) a free-radically polymerizable surfactant;
coating the blend on a substrate; and
removing the aqueous carrier.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

FIG. 1 is a side view of an article including a backing, a release coating on a major surface, and a pressure sensitive adhesive on the opposing major surface of the backing;

FIG. 2 is a side view of another article comprising a release coated backing and a separate pressure sensitive adhesive coated substrate; and

FIG. 3 is a side view of another article comprising a backing with release coating on both major surfaces and a pressure sensitive adhesive between the release-coated surfaces.

It should be understood that numerous other modifications and embodiments can be devised by those skilled in the art, which fall within the scope and spirit of the principles of the disclosure. The figure may not be drawn to scale.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“backbone” refers to the main continuous chain of the polymer;
“crosslinking” refers to connecting two pre-formed polymer chains using chemical bonds or chemical groups;
“cure site” refers to functional groups, which may participate in crosslinking;
“interpolymerized” refers to monomers that are polymerized together to form a polymer backbone;
“monomer” is a molecule which can undergo polymerization which then form part of the essential structure of a polymer;
“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and
“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

The term “(meth)” in front of acrylic or acrylate, refers to either the molecule being methylated, and/or not methylated. For example, “(meth)acrylate” refers to an acrylate (CH2=CHC(═O)O—) or a methacrylate (CH2=CCH3C(═O)O—) structure or combinations thereof.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

In the present disclosure, it has been found that a blend of a silicone-containing (meth)acrylic polymer and a (meth)acrylic polymer as described below can be dried and/or activated at low temperatures and surprisingly achieve good release properties.

First Polymer

The first polymer is a silicone-containing (meth)acrylic polymer derived from silicone containing monomers and acrylate containing monomers. In one embodiment, the first polymer comprises a (meth)acrylate backbone with pendent silicone groups. In another embodiment, the first polymer comprises a silicone backbone with pendent (meth)acrylate groups.

In one embodiment, the silicone containing monomers include mercapto functional silicone macromolecular chain transfer agents such as pendant functional mercaptopolydiorganosiloxane copolymers that are described by the following general formula (1):

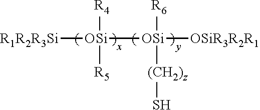

wherein: R₁, R₂, and R₃ are monovalent moieties that can independently be the same or different and are selected from the group consisting of alkyl, aryl, alkylaryl, alkoxy, alkylamino, hydroxyl, hydrogen, fluoroalkyl, divalent linking groups and are most preferably alkyl moieties; R₄, R₅, and R₆ are monovalent moieties that can independently be the same or different and are selected from the group consisting of alkyl, aryl, alkylaryl, alkoxy, alkylamino, hydroxyl, hydrogen, fluoroalkyl and are most preferably alkyl moieties; z can range from 1 to about 16, preferably 1 to 5 and is most preferably 3; x and y are integers of at least one and the sum of x+y is an integer of 10 or greater; and y can range from 0.5 to about 80% of (x+y); preferably from 1-20% of (x+y) and most preferably from 3.5-14% of (x+y).

Exemplary pendant functional mercaptopolydiorganosiloxane copolymers according to Formula I are commercially available from Shin-Etsu, Inc. Akron, Ohio, under the commercial designation of “KF-2001” wherein R₁, R₂, R₃, R₄, R₅, and R₆ are all —CH₃, y is 3.5 to 4.5% of (x+y), z is 3, and the number average molecular weight (Mn) is 8000 g/mol. Additional copolymers according to Formula I having varying values of R, x, y, and z are commercially available from Huls America, Inc. (Piscataway, N.J.)

The term silicone containing monomer as used herein also includes silicone macromonomers having the general formula (2):

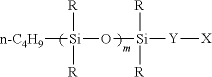

wherein: X is a polymerizable vinyl group; Y is a divalent linking group selected from the group consisting of —CH₂—, —CH₂CH₂—, and —CH₂CH₂CH₂—; m is 20 to 2000; each R is independently selected from the group consisting of hydrogen, alkyl, aryl, and alkoxy, wherein the alkyl and alkoxy group comprise 1, 2, 3,4 5, 6, 7, or 8 carbon atoms, and the aryl group comprises 4, 5, 6, 7, or 8 carbon atoms.

Preferably the formulas of the silicone macromonomer are selected such that X is selected from the group consisting of:

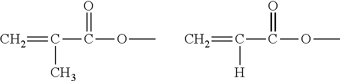

Preferably, the macromonomer is represented by the general formula (4):

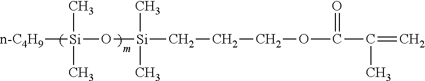

wherein m is 100 to 150, (prepared according to procedures described in U.S. Pat. No. 4,728,571) or commercially available from Shin-Etsu Inc. as X-22-2426.

Preferably, the first polymer comprises about 15 to about 45 percent by weight, more preferably 25 to about 45 percent by weight of the silicone containing monomer, based upon the total weight of all of the monomers.

In one embodiment, the acrylate containing monomers used to derive the first polymer include: one or more short chain alkyl acrylate or alkyl methacrylate monomers, wherein the alkyl group contains less than about 12 carbon atoms. Useful monomers include but are not limited to those chosen from the group consisting of alkyl esters of acrylic and methacrylic acid, such as methyl acrylate, ethyl acrylate, isobornyl acrylate, hydroxyethyl acrylate, methyl methacrylate, ethyl methacrylate, etc. and mixtures and combinations thereof.

Preferably, the first polymer comprises about 25 to about 85 percent by weight, more preferably 45 to about 75 percent by weight of the short chain alkyl acrylate or alkyl methacrylate monomer(s), based upon the total weight of all of the monomers.

In one embodiment, a hydrophilic comonomer is polymerized into the first polymer to assist in making the first polymer compatible with aqueous solutions. Exemplary hydrophilic comonomers include carboxylic acid-containing monomers such as acrylic acid, methacrylic acid, itaconic acid, maleic acid, and salts thereof; and nitrogen-containing monomers such as N-vinyl pyrrolidone, N-vinyl caprolactam, acrylamide, N, N-dimethyl acrylamide. N,N-dimethyl-aminoethyl(methyl)acrylate, N,N-dimethylaminopropyl(meth)acrylate, t-butylaminoethyl(methyl)acrylate and N,N-diethylaminoacrylate, (meth)acrylonitrile, furfuryl (meth)acrylate and tetrahydrofurfuryl (meth)acrylate, 2-vinyl pyridine, and 4-vinyl pyridine; and mixtures and combinations thereof.

In a preferred embodiment, the first polymer is a latex, in other words, particles of silicone-containing (meth)acrylic polymer in an aqueous medium. In one embodiment, the first polymer is prepared by the polymerization of silicone containing monomers and acrylate containing monomers in an aqueous medium in the presence of an emulsifier. Such polymerizations are known in the art, see for example, U.S. Pat. No. 6,420,480 (Ozdeger) herein incorporated by reference.

In another embodiment, the first polymer is prepared by the polymerization of silicone containing monomers and acrylate containing monomers in a solvent based process as known in the art. In one embodiment, the solvent-based dispersion of the first polymer can be inverted into an aqueous medium to achieve a water-borne first polymer.

Second Polymer

The second polymer is a (meth)acrylic polymer. Such polymers are derived from i) a first monomer having an alkyl group with 12 to 24 carbon atoms, a linking group containing a nitrogen or ester group, and a free-radically polymerizable (meth)acryl group; and ii) a second free-radically polymerizable monomer having less than 12 carbon atoms.

The first monomer has an alkyl group with 12 to 24 carbon atoms, a nitrogen-containing or

ester linking group, and a free-radically polymerizable group. Such first free-radically polymerizable monomer may be characterized as a “long-chain” monomer.

The long-chain monomer typically has the following general formula (3):

CₙH₂ₙ₊₁—Y—CₘH₂ₘ—X—CR¹=CH₂
wherein n ranges from 12 to 24;
Y is a divalent polar linking group;
m ranges from 2 to 10;
X is a divalent linking group selected from ester or amide; and
R₆ is H or CH₃.

In typical embodiments, Y is an ester group or a nitrogen-containing group such as urethane or amide. Representative Y groups include for example

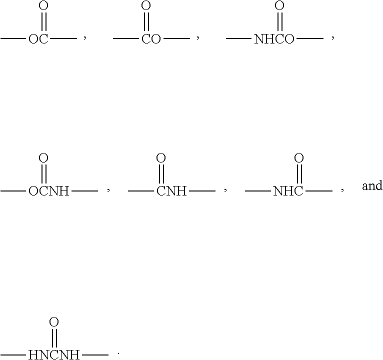

In typical embodiments, the alkyl group, CₙH₂ₙ₊₁—, is of sufficient chain length such that the monomer or polymerized monomer crystallizes at room temperature. In typical embodiments, n is at least 12, 13, 14, 15, 16, 17, or 18.

In some embodiments, m is at least 2 and typically no greater than 3 or 4.

In some favored embodiments, Y is a nitrogen-containing group. In some favored embodiments, Y is a urethane group. One representative long chain monomer is octadecyl carbamoyl ethyl acrylate (ODCEA) depicted as follows:

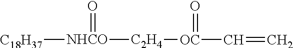

Other long chain monomers include for example octadecanoyl ethyl acrylate (ODEA) and hexadecyl carbamoyl ethyl acrylate (HDCEA) depicted as follows:

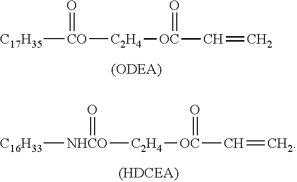

Yet other examples of long chain monomers are described in U.S. Pat. No. 5,225,480; incorporated herein by reference.

In some embodiments, a combination of at least two long-chain monomers of different types (e.g. different Y and/or different X groups) or of the same type but different alkyl chain lengths may be utilized.

The long-chain monomers are polymerized with one or more suitable second free-radically polymerizable monomers. The second monomer does not contain an alkyl group having at least 12 carbon atoms. In typical embodiments, the second monomer typically comprises an alkyl group containing less than about 12 carbon atoms. Examples of second free-radically polymerizable monomers include but are not limited to the following: vinyl halides such as vinylidene chloride, etc.; vinyl ethers such as vinyl propyl ether, vinyl butyl ether, etc.; vinyl esters such as vinyl acetate, vinyl propionate, vinyl butyrate, vinyl benzoate, etc.; (meth)acrylic esters such as methyl acrylate, ethyl acrylate, isobornyl acrylate, tetrahydrofurfuryl acrylate, hydroxyethyl acrylate, glycidyl acrylate, etc.; methacrylic esters such as ethyl methacrylate, butyl methacrylate, hexyl methacrylate, tetrahydrofurfuryl methacrylate, hydroxyethyl methacrylate, glycidyl methacrylate, etc.; acids such as acrylic acid, methacrylic acid, etc.; amides such as acrylamide, methacrylamide, etc.; aromatic vinyl compounds such as styrene, vinyl toluene, etc.; heterocylic vinyl monomers such as vinyl pyrrolidone, vinyl pyridine, etc.; vinyl nitriles such as acrylonitrile, methacrylonitrile, etc.; allyl compounds such as allyl glycidyl ether, etc.; esters and half-esters of diacids such as diethyl maleate, monomethyl itaconate, monobutyl itaconate, etc.; and mixtures thereof.

The second monomer is more typically comprises an alkyl or alkylene group having 2 to 4 carbon atoms such as vinyl acetate, vinyl propionate, methyl acrylate, butyl methacrylate, hydroxyethyl acrylate, methacrylic acid, glycidyl methacrylate, and mixtures thereof. Preferably, the second monomer is vinyl acetate, vinyl propionate, and mixtures thereof.

The weight ratio of the long-chain monomer to the second monomer can range from about 10:90 to about 90:10 depending upon the type of PSA to be used and the desired release performance. In some embodiments, the weight ratio of the long-chain hydrocarbon monomer to the second monomer is at least 15:85, 20:80, 25:75, 30:70, 35:65 or 40:60. In some embodiments, the weight ratio of the long-chain hydrocarbon monomer to the second monomer is no greater than 80:20, 75:25, 70:30, 65:35 or 60:40.

In a preferred embodiment, the second polymer is a latex. In one embodiment, the first and the second monomers are polymerized in an aqueous medium in the presence of a polymerizable emulsifier. Polymerizable emulsifiers (or polymerizable surfactants) useful in conventional emulsion polymerizations may be categorized as anionic, nonionic, amphoteric, and cationic.

Useful anionic surfactants include but are not limited to sulfosuccinates and derivatives, alkylaryl sulfonates, olefin sulfonates, phosphate esters, sulfates and sulfonates of ethoxylated alkylphenols, sulfates and sulfonates of ethoxylated fatty alcohols, sulfates of fatty esters, and mixtures thereof.

Useful nonionic surfactants include but are not limited to ethoxylated fatty alcohols, ethoxylated fatty esters, ethoxylated fatty acids, ethoxylated alkylphenols, ethylene oxide-propylene oxide block copolymers, and mixtures thereof.

Useful cationic surfactants include but are not limited to long chain amines and their salts, quaternary ammonium salts, and mixtures thereof.

Useful amphoteric surfactant include, but are not limited to, betaine derivatives, sulfobetaine derivatives, and mixtures thereof.

The surfactants used herein further comprise a free radically polymerizable group, such as a vinyl or (meth)acrylate group. Thus, the surfactant is copolymerized into the polymer chain of the latex polymer. The polymerizable surfactant may be aromatic or aliphatic. The polymerizable surfactant is typically an anionic surfactant, comprising a sulfur-containing or phosphorous-containing anion. The polymerizable surfactant typically further comprises an ethylene oxide (e.g. E-O) repeat unit. One representative class of such surfactants are sulfates and sulfonates of ethoxylated alkylphenols and alkylphenyls. Some representative structures are as follows wherein m and n is the number of repeat units:

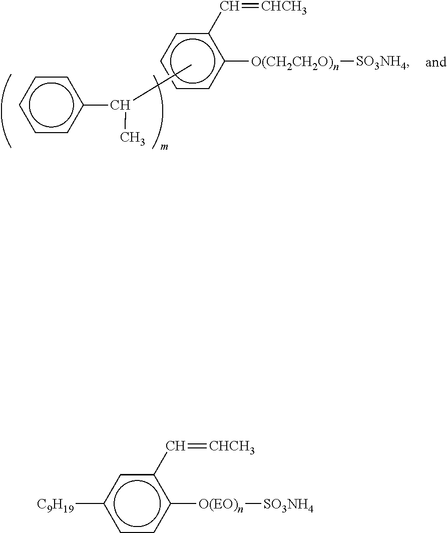

Another representative class of such surfactants are sulfates and sulfonates of ethoxylated alkyl ethers. One representative structure is as follows:

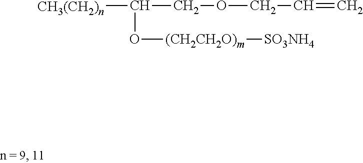

Each of these structures can have other anionic groups, such as phosphates. Each of the structures can have various numbers of ethylene oxide repeat units (i.e., n of the first two structures and m of the third structure). Typically, the number of ethylene oxide units is at least 5 or 10 and no greater than 50, 45, 40, 35 or 30. In some embodiments, the number of ethylene oxide units is less than 25, 20, or 15. Polymerizable surfactants are commercially available from DKS, Japan as the trade designations HITENOL AR1025, HITENOL AR2025, HITENOL AR 3025, HITENOL BC-1025, and HITENOL KH-1025. Anionic copolymerizable surfactant are also available from Croda Inc., Newark, NJ under the trade designation “MAXEMUL 6106-LQ-(MH)” and “MAXEMUL 6112-SO(MH)”.

The amount of polymerizable surfactant is typically at least 1, 2, 3, 4, or 5 wt. % solids based on the total weight solids of the dried waterborne latex emulsion. In some embodiments, the amount of polymerizable surfactant is no greater than 15, 14, 13, 12, 11, 10, 9, 8, or 7 wt. % solids based on the total weight solids of the dried waterborne latex emulsion.

Mixtures of polymerizable surfactants may be utilized. In typical embodiments, little or no conventional non-polymerizable surfactants are utilized in the composition described herein. In typical embodiments, the final waterborne polymeric emulsions contain little or no “free” surfactant, i.e., surfactant that is not covalently bonded to the polymer chain of the latex polymer. The amount of surfactant that is not covalently bonded to the polymer chain of the latex polymer is typically less than 500, 400, 300, 200 or 100 ppm (0.1 wt. % solids of the dried latex).

The latex polymer emulsion is prepared by methods known in the art, such as described in previously cited U.S. Pat. No. 5,225,480 and U.S. Prov. Appl. No. 63/056,035 filed Jul. 24, 2020, herein incorporated by reference.

Blends

The first and second polymers are blended together to form the release coating.

In one preferable embodiment, an aqueous dispersion of the first polymer is blended with an aqueous dispersion of the second polymer. The two aqueous dispersions are contacted together and then blended using techniques known in the art such as using an overhead mixer and/or inline mixing to form the release coating.

The release coating may optionally comprise various additives as known in the art such as pH modifiers, wetting agents, dyes, pigments, biocides/antimicrobial agents, coalescing agents, film forming agent, rheology modifiers, and defoamers, may be added. It may be desirable to maintain the pH of the aqueous based release coating within a certain range and therefore, pH buffers such as sodium bicarbonate, sodium hydrogen phosphate, ammonium hydroxide, sodium hydroxide and the like may be used to maintain a particular pH. Coalescing agents may be admixed with the latex in order to ensure adequate coverage of a coating thereof onto a substrate. Useful coalescing agents include but are not limited to N-methylpyrrolidone, toluene, xylene, ethyl acetate, methyl ethyl ketone, alcohols (e.g., isopropyl alcohol), and mixtures thereof. Useful film forming agents include, but are not limited to, acrylic emulsions including, for example, polyvinyl acetates; polyurethane dispersions; etc. Useful rheology modifiers include but are not limited to, hydroxyethyl cellulose, poly(ethylene glycol), and mixtures thereof. When present the total amount of such additive(s) is typically no greater than 15, 14, 13, 12, 11, 10, 9, 8, 7, 6, 5, 4, 3, 2, 1 wt. %, based on the total dried release coating.

It is advantageous that the release coating comprises a low amount, or even no, free surfactant. To achieve low amounts of surfactant, a polymerizable surfactant may be used during the polymerization of the polymer, no surfactant could be used (typically a solvent based polymerization process), and/or the free surfactant could be removed from the polymer using techniques known in the art. In one embodiment, the release coating comprises less than 100, 50, 10, 5 or even 1 ppm (parts per million) of free (unbound) surfactant.

In one embodiment, the release coating comprises at least 5, 10, 15, 20 or even 25% by weight and no more than 30, 40, or even 50% by weight of the second polymer per the total amount of solids present.

The desired concentration of latex polymer in the aqueous carrier liquid of the emulsion depends upon the method of coating and upon the desired coating thickness. The aqueous carrier liquid comprises at least 75, 80, 85 or 90 wt. % water optionally in combination with organic solvents (e.g., coalescing agent), as previously described. In some embodiments, a polymer latex of a higher percentage solids content obtained from the emulsion polymerization process can be diluted with water to a lower concentration. In some embodiments, the weight percent solids of latex polymer is at least 2, 3, 4, 5, 6, 7, 8, 9 or 10 wt. % solids. In some embodiments, the weight present solids of latex polymer is no greater than 60, 50, 40, 35, 30, 25, or 20 weight percent solids. By varying the percent solids of the coating solution (for example, from 2% and 30%), and the wet coating thickness (for example, from 5 μm to 30 μm), a range of coat weights may be prepared if desired.

For some applications, the coating solution has a low solids content (e.g., 3%) resulting in a release layer having a dried thickness of at least 0.05, 0.10, or even 0.15; and at most 0.20, 0.25, 0.40, 0.50 or even 0.60 micrometers.

In some applications, the coating solution has a higher solids content and/or is coated at thicker, and the thickness of the coating is reduced by stretching the coated substrate, as known in the art. In some embodiments, the thickness of the dried release coating is typically at least 10, 12, 15, or even 20 micrometers; and no more than 50, or even 25 microns. The release layer after stretching has a dried thickness of at least 0.05, 0.1, or even 0.2 micrometers; and at most 4, 2, 1, or even 0.25 micrometer.

The coating composition may be applied to a suitable substrate by means of conventional coating techniques such as wire-wound rod, direct gravure, offset gravure, reverse roll, air-knife, and trailing blade coating.

Typically, the coating is heated to activate the release layer. This temperature is dictated by the temperature needed to form a layer having sufficient release properties. This temperature will dictate the substrate used, as too high of a temperature can cause some substrates to deform or shrink. The release coatings of the present disclosure can be activated at lower temperatures and still achieve good release properties even upon aging. This is unexpected because long chain alkyl release agents (for example, 16 to 22 carbons in length) have required drying or annealing temperatures approaching the melting point of the long chain alkyl so that orientation of those long chains can occur, allowing for adequate release performance. Lower activation temperatures mean that the coating composition can be activated at temperatures of at least 20, 23, or even 25° C. and at most 50, 45, 40, or even 35° C. Not only can lower activation temperatures enable the use of substrates having lower process temperatures (for example, substrates having a lower softening or melting temperature), the lower activation temperatures can also enable faster processing. For example, the multilayered coating compositions disclosed herein can be made via continuous web processing. The use of lower activation temperatures enable faster web speeds since the resulting bulk web temperatures remain near room temperature.

Suitable substrates include paper, metal sheets and foils, nonwoven fabrics, and films of thermoplastic resins such as polyesters such as polyethylene terephthalate (PET), polylactic acid (PLA) and polyethylene naphthalate (PEN), polyamides, polyolefins such as polyethylene and polypropylene (e.g., biaxial oriented polypropylene BOPP), polycarbonates, polyvinyl chloride, etc., although any surface requiring release toward adhesives can be used. In some embodiments, the thickness of the substrate is at least 0.5, 1 or 2 mils and typically no greater than 5, 10 or 15 mils.

One or both major surfaces of the substrate (e.g., backing) may further comprise a primer layer or be surface treated (e.g., corona treated), as known in the art to promote adhesion of the release coating, adhesive or both.

In one embodiment, the release coated substrate comprises a pressure sensitive adhesive (PSA). The resulting PSA articles may be a tape, label, or wound dressings. The articles may be in the form of a sheet, multilayer sheet, or stack of sheets (e.g., note pad, easel pad, label pad, tape stack), or in the form of a roll, such as a roll of tape.

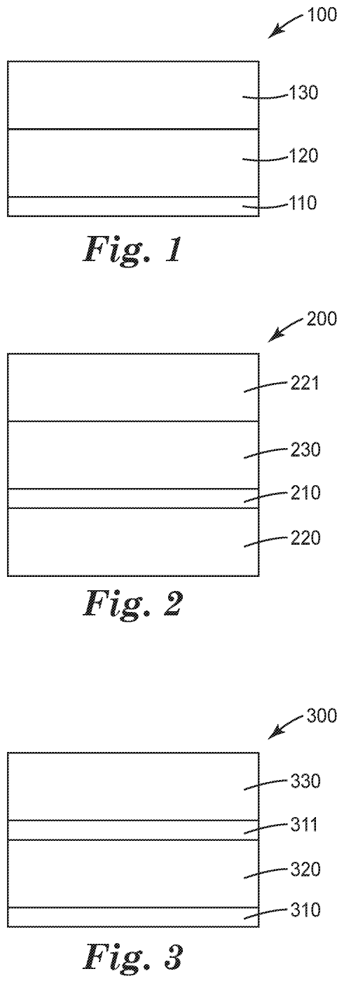

One illustrative PSA article 100 is shown in FIG. 1. This embodied (e.g., tape) article comprise release coating 110 disposed on a major surface of substrate (e.g., backing) 120 and a pressure sensitive adhesive 130 disposed on the opposing major surface of 120.

FIG. 2 depicts another PSA article 200. This embodied article comprising a release coating 210 disposed on a major surface of substrate (e.g., backing) 220. A pressure sensitive adhesive 230 is releasably bonded to the release coating 210. The pressure sensitive adhesive is disposed on a major surface of a second substrate 221.

FIG. 3 depicts another PSA article 300. This embodied (e.g., tape) article comprises release coatings 310 and 311 disposed on both major surfaces of substrate (e.g., backing) 320 and a pressure sensitive adhesive 330 releasably bonded to release coating 311. One or both of release coatings 310 and 311 are a release coating as described herein.

The release coating described herein is suitable for use with a wide variety of pressure sensitive adhesive compositions. Suitable (e.g., pressure sensitive) adhesives include natural or synthetic rubber-based pressure sensitive adhesives, acrylic pressure sensitive adhesives, vinyl alkyl ether pressure sensitive adhesives, silicone pressure sensitive adhesives, polyester pressure sensitive adhesives, polyamide pressure sensitive adhesives, poly-alpha-olefins, polyurethane pressure sensitive adhesives, and styrenic block copolymer based pressure sensitive adhesives. Pressure sensitive adhesives generally have a storage modulus (E′) as can be measured by Dynamic Mechanical Analysis at room temperature (25° C.) of less than 3×10⁶ dynes/cm at a frequency of 1 Hz.

The pressure sensitive adhesives may be organic solvent-based, a water-based emulsion, hot melt (e.g., such as described in U.S. Pat. No. 6,294,249), heat activatable, as well as an actinic radiation (e.g., e-beam, ultraviolet) curable pressure sensitive adhesive.

The pressure sensitive adhesive may further include one or more suitable additives. Suitable additives are exemplified by crosslinking agents (e.g. multifunctional (meth)acrylate crosslinkers (e.g. TMPTA), epoxy crosslinking agents, isocyanate crosslinking agents, melamine crosslinking agents, aziridine crosslinking agents, etc.), tackifiers (e.g., phenol modified terpenes and rosin esters such as glycerol esters of rosin and pentaerythritol esters of rosin, as well as C5 and C9 hydrocarbon tackifiers), thickeners, plasticizers, fillers, antioxidants, ultraviolet absorbers, antistatic agents, surfactants, leveling agents, colorants, flame retardants, and silane coupling agents.

It is appreciated that different release compositions are preferred for different pressure sensitive adhesive compositions. It is also appreciated that different types of adhesive articles have different preferred release properties.

The release and readhesion properties can be determined according to the test methods in the examples.

The average release force of the release coating can generally range from 0.5 ounce/inch to ounces/inch at a peel rate of 90 inches (228.6 cm)/min. In some embodiments, the average release is no greater than 45, 40, 35, 30, 25, 20, 15, 10 or 5 ounces/inch at a peel rate of 90 inches (228.6 cm)/min.

In some embodiments, the average release force is at least 2, 3, 4, 5, 6, or 7 (22.3, 33.5, 44.6, 55.8, 78.1 g/cm) ounces/inch at a peel rate of 90 inches (228.6 cm)/min. A higher average initial release force at slower peel rates can be preferred in some embodiments to prevent a roll of tape from self-unwinding or to provide greater holding power when over taping occurs such as for packaging tape.

The readhesion of the release coating is typically no greater than 100, 50, 45, 40, 35, 30, 20, or 15 ounces/inch at a peel rate of 90 inches (228.6 cm)/min.

In some embodiments, the difference in release force and/or readhesion between 7 days at 23° C. and 50% humidity or at 50° C. is no greater than 50, 40, 30, 20, 15, 10, 5, 2, or 1% of the average CM value.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

TABLE 1
Materials Used in the Examples

| Abbreviation | Description and Source |
|---|---|
| ODCEA | Octadecyl ethyl carbamate acrylate, synthesized as |
| | described below. |
| VAc | Vinyl acetate obtained from Celenese Pte Ltd, Irving, |
| | Texas, USA |
| MA | Methyl acrylate obtained from BASF, Florham Park, |
| | New Jersey, USA |
| KF-2001 | Mercapto-functional silicone obtained from Shin Etsu |
| | Silicones Akron, Ohio, USA |
| NVP | N-Vinylpyrrolidone obtained from Ashland, Wilmington, |
| | Delaware, USA |
| AA | Acrylic Acid obtained from BASF, Florham Park, New |
| | Jersey, USA |
| HT-1025 | A polyoxyethylene styrenated phenyl ether ammonium |
| | sulfate anionic emulsifier, obtained under the trade |
| | designation “HITENOL AR-1025” Dai-ichi Kogyo |
| | Seiyaku, Kyoto, Japan |
| VAZO 67 | 2,2′-Azobis(2-methylbutyronitrile), Chemours Company, |
| | Wilmington, Delaware |
| PSA-336 | A surfactant available under the trade designation |
| | “Surfynol-PSA-336” from Evonik, Allentown, |
| | Pennsylvania, USA |
| NaHCO₃ | Sodium bicarbonate obtained from Church & Dwight |
| | Co., Inc, Ewing, New Jersey, USA |
| NH₂S₂O₈ | Ammonium persulfate obtained from Univar, Downers |
| | Grove, Illinois, USA |
| 3M 375+ Tape | 3M Packaging Tape, styrene-isoprene-styrene block |
| | copolymer rubber based, tackified adhesive, obtained |
| | from 3M Company, St. Paul, Minnesota, USA |
| PP Film | Extruded polypropylene film made from polypropylene |
| | homopolymer resin, melt index (2.16 Kg-230° C.) of |
| | 2.8 g/10 min available as 3371 from Total |
| | Petrochemicals & Refining S.A./N.V., Brussels, Belgium |

### Procedures

### Synthesis of Octadecyl Carbamoyl Ethyl Acrylate (ODCEA)

1 equivalent of octadecyl isocyanate (obtained under trade designation MILLIONATE 0 (P) Hodogaya Chemical, White Plains, New York) was charged into a 500 ml flask containing a solution comprising 1.01 equivalents of hydroxyethyl acrylate (obtained from Kowa American Corporation New York, New York), a trace amount of dibutyltin dilaurate catalyst (obtained from Sigma Aldrich Chemical Corp., St. Louis, Missouri), and required amount of ethyl acetate to make a 30% solids solution. The reaction mixture was stirred and allowed to react overnight at 50° C. Upon cooling, the precipitate formed was isolated by filtration, recrystallized from ethyl acetate, and dried under vacuum at 40° C. for 48 hours to provide ODCEA monomer. The solid monomer was analyzed using nuclear magnetic resonance and Infrared spectroscopy to monitor the conversion and the purity of the ODCEA monomer.

### First Polymer Synthesis

To a flask (equipped with a water condenser connected to a bubbler on top, a stirring shaft, a nitrogen inlet, and a thermocouple) was charged the appropriate amount of methyl ethyl ketone (MEK) solvent to yield a 40% solids solution when polymerized. Then N-vinylpyrrolidone (NVP), mercapto-functional silicone (KF-2001), methyl acrylate (MA), and acrylic acid (AA) were charged to the flask with MEK. The ratios of the monomers were NVP/KF-2001/MA/AA by weight. The flask was sealed and purged with nitrogen gas and slowly heated to 55° C. with stirring. Once a stable 55° C. temperature was attained, 0.25 wt. % (based on the monomers) of VAZO 67 was charged through the nitrogen port. The contents in the flask were polymerized for 20 h. The 40% solids sample in MEK was then tested for various properties including, percent solids, IV, and appearance.

The 40% solids solvent-borne material was then charged to a flask equipped with a distillation/condenser attachment connected to a vacuum/receiving flask, a stirring shaft, and a thermocouple. The flask was gently heated to 45° C. To the flask was then added (while stirring) the appropriate amount of water to achieve the target 30% solids of inverted product in water. A base (either triethylamine or ammonium hydroxide) was added (while stirring) in an amount such that the acrylic acid was neutralized. Once a homogenous solution results, vacuum was slowly pulled until the MEK solvent was slowly collected into the receiving flask. The vacuum distillation continued until the MEK was removed. The resulting product was an inverted water-based silicone acrylate at 30% solids. The inverted product was tested for physical properties including percent solids, pH, and residual MEK level.

### Second Polymer Synthesis

In a clean reactor fitted with a mechanical stirrer, a thermocouple, and nitrogen inlet/outlet were added the monomers (ODCEA and VAc) at a ratio of 25:75 (total 100 parts by weight), copolymerizable emulsifier (HT-1025) (6 parts by weight with respect to the monomer mixture), sodium bicarbonate (2.5 parts by weight with respect to the monomer mixture), and water (amount determined by percent solids) were charged. The reaction mixture was heated to 75° C. and then passed twice through a high-pressure homogenizer from Microfluidizer Inc. (obtained from Microfluidics, Westwood, Massachusetts) preheated at 75° C. After homogenization, the reaction mixture was charged back to the reactor and sealed. The reaction mixture was purged with nitrogen and then charged with ammonium persulfate (2.5 parts by weight with respect to the monomer mixture). The reaction mixture was maintained at 75° C. for 12 h, followed by being cooled to room temperature, filtered through a 5 μm filter, and examined for coagulum. The resulting latex was analyzed for percent solids (gravimetrically), pH, and particle size by dynamic light scattering (Brookhaven NanoBrook 90Plus PALS). Latex solutions were diluted to 5% to 30% solids with additional DI water before use.

### Blend Preparation

The First Polymer was charged to a flask equipped with an overhead mixer. With stirring, the appropriate amount of Second Polymer was slowly added to yield a homogenous blend. This was further diluted out to the target % solids by charging with water. Depending on the substrate used, an appropriate amount of PSA-336 may be added to assist in the wetting out of the substrate. Shown in Table 2 below is the ratio of First Polymer to Second Polymer in each blend

TABLE 2

% by weight

| Blend | Second Polymer | First Polymer |
|---|---|---|
| P1A | 100 | 0 |
| P1B | 75 | 25 |
| P1C | 50 | 50 |
| P1D | 40 | 60 |
| P1E | 35 | 65 |
| P1F | 30 | 70 |
| P1G | 25 | 75 |
| P1H | 20 | 80 |
| P1I | 15 | 85 |
| P1J | 10 | 90 |
| P1K | 0 | 100 |

### Preparation of Release Coated Substrate

Each of the blends was coated onto PP Film using a notch bar coater with a #6 Meyer Rod. The coated PP Film was slowly pulled through by hand and placed onto a particle board. The coated PP Film was dried at 30° C. for a minimum of 1 minute to form about a 0.6 micrometer thick coating.

### Test Methods

### Preparation of Laminates for Release and Readhesion Testing

### Release Test

3M 375+ Packaging Tape (3M Co., Maplewood, MN) was used to evaluate the release performance of prepared coatings on PP film backings. Coated strips of film (PP, 1 in×8 in) were adhered to a glass plate using double-sided tape such that the coated side of the release coated substrate was facing up (out). A strip of 3M 375+ Packaging Tape (1 in×8 in) was then cut and laminated with its adhesive against the release coated substrate using a 5-lb rubber roller rolled twice back and forth over the strips. The laminated tape stripes were aged at two different conditions for 7 days unless otherwise indicated: condition (1) 23° C., 50% relative humidity and condition (2) 50° C. in an oven. Once the samples were aged, the 3M 375+ Packaging Tape was peeled from the release coated substrate using a peel tester (Model IMASS SP-2000 Slip/Peel Tester, available from IMASS, Incorporated, Accord, MA) at an angle of 180° and at a rate of 12 in/min and 90 in/min with a data averaging time of 5 seconds. An average value for 3 peel tests is reported in the tables below.

### Readhesion Test

Glass plates were cleaned by successively wiping them with hexanes, isopropanol, and methyl ethyl ketone using a KIMWIPE (Kimberly-Clark Corporation, Neenah, WI) wetted with the solvents. Following the release testing above, the “used” 3M 375+ Packaging Tape was laminated onto a clean glass surface using a 5-lb roller which was rolled back and forth once on the tape strip before measuring the readhesion force. Peel force data were collected in the same manner as above and an average of 3 measurements is reported as readhesion force in the tables below.

TABLE 3
Release and Readhesion Results at 12 in/min (30 cm/min)

| | 23° C., 50% relative humidity | | 50° C. | |
|---|---|---|---|---|
| Blend used in | Release | Readhesion | Release | Readhesion |
| release coating | (oz/in) | (oz/in) | (oz/in) | (oz/in) |
| P1A | N/A | | N/A | |
| P1B | 30.68 | 51.00 | 20.88 | 58.63 |
| P1C | 4.96 | 39.75 | 15.81 | 40.01 |
| P1D | 3.80 | 39.61 | 11.14 | 36.34 |
| P1E | 3.48 | 40.22 | 9.98 | 39.06 |
| P1F | 3.02 | 39.91 | 8.52 | 36.79 |
| P1G | 3.20 | 39.55 | 7.36 | 38.39 |
| P1H | 3.32 | 37.62 | 5.07 | 40.78 |
| P1I | 3.45 | 39.71 | 4.61 | 39.11 |
| P1J | 2.61 | 38.76 | 3.78 | 40.57 |
| P1K | 2.22 | 34.04 | 6.59 | 35.99 |

N/A—Release could not be measured due to excessively high peel force (or adhesive locking to the release material).

TABLE 4
Release and Readhesion Results at 90 in/min (2.3 m/min)

| | 23° C., 50% relative humidity | | 50° C. | |
|---|---|---|---|---|
| Blend used in | Release | Readhesion | Release | Readhesion |
| release coating | (oz/in) | (oz/in) | (oz/in) | (oz/in) |
| P1A | N/A | | N/A | |
| P1B | 20.99 | 73.12 | 20.70 | 73.25 |
| P1C | 2.34 | 63.58 | 6.63 | 60.18 |
| P1D | 2.40 | 62.87 | 5.94 | 59.57 |
| P1E | 2.69 | 63.25 | 6.20 | 59.73 |
| P1F | 2.80 | 62.52 | 5.10 | 62.24 |
| P1G | 2.98 | 60.77 | 3.86 | 60.76 |
| P1H | 2.89 | 62.42 | 4.56 | 59.58 |
| P1I | 3.16 | 63.36 | 5.58 | 61.85 |
| P1J | 3.20 | 62.59 | 3.72 | 61.67 |
| P1K | 3.26 | 54.64 | 3.55 | 57.06 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A release-coated substrate comprising:
a release layer disposed on a substrate, the release layer comprising a blend of:
(a) a first polymer silicone-containing (meth)acrylic polymer; and
(b) a second polymer (meth)acrylate polymer, wherein the acrylate polymer comprises the polymerization reaction product of:
(i) a first monomer having an alkyl group with 12 to 24 carbon atoms, a linking group containing a nitrogen or ester group, and a free-radically polymerizable (meth)acryl group;
(ii) a second free-radically polymerizable monomer having less than 12 carbon atoms.

2. The release-coated substrate of claim 1, wherein the release layer comprises 5 to % by weight of the second acrylate polymer.

3. The release-coated substrate of claim 1, wherein the first monomer has the formula:
CₙH₂ₙ₊₁—Y—CₘH₂ₘ—X—CR⁶═CH₂ (3)
wherein n ranges from 12 to 24;
Y is a nitrogen-containing or ester linking group;
m ranges from 2 to 10;
X is a divalent linking group selected from ester or amide; and
R⁶ is H or CH₃.

4. The release-coated substrate of claim 1, wherein the first monomer has an alkyl group with at least 16, 17, or 18 carbon atoms.

5. The release-coated substrate of claim 1, wherein the first monomer comprises a urethane linking group.

6. The release-coated substrate of claim 1, wherein the free-radically polymerizable (meth)acryl group is (meth)acrylate or (meth)acrylamide.

7. The release-coated substrate of claim 1, wherein the second polymer is further derived from (iii) polymerizable surfactant.

8. The release-coated substrate of claim 7, wherein the polymer comprises 1 to 15 wt. % of polymerized units of the free-radically polymerizable surfactant based on the total amount of (i) and (ii).

9. The release-coated substrate of claim 7, wherein the polymerizable surfactant comprises ethylene oxide repeat units.

10. The release-coated substrate of claim 1, wherein the second monomer comprises an alkyl or alkylene group having 2 to 4 carbon atoms.

11. The release-coated substrate of claim 1, wherein the silicone-containing polymer is a mercapto- and/or (meth)acrylate-modified silicone polymer.

12. The release-coated substrate of claim 11, wherein the mercapto- and/or (meth)acrylate-modified silicone polymer comprises a graft copolymer or block copolymer represented by Formula (1): 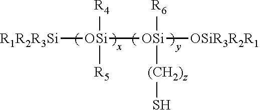
wherein: R₁, R₂, and R₃ are monovalent moieties that can independently be the same or different and are selected from the group consisting of alkyl, aryl, alkylaryl, alkoxy, alkylamino, hydroxyl, hydrogen, and fluoroalkyl, divalent linking groups; R₄, R₅, and R₆ are monovalent moieties that can independently be the same or different and are selected from the group consisting of alkyl, aryl, alkylaryl, alkoxy, alkylamino, hydroxyl, hydrogen, and fluoroalkyl moieties; z can range from 1 to about 16; x and y are integers of at least one and the sum of x+y is an integer of 10 or greater; and y can range from 0.5 to about 80% of (x+y).

13. The release-coated substrate of claim 11, wherein the mercapto and/or (meth)acrylate modified silicone polymer comprises a graft copolymer or block copolymer represented by Formula (2): 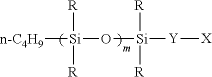
wherein: X is a polymerizable vinyl group; Y is a divalent linking group selected from the group consisting of —CH₂—, —CH₂CH₂—, and —CH₂CH₂CH₂—; m is 20 to 2000; each R is independently selected from the group consisting of hydrogen, C₁₋₈ alkyl, aryl, and alkoxy.

14. The release-coated substrate of claim 1, wherein the release layer is at least 25 nm to at most 1 micrometer in thickness.

15. The release-coated substrate of claim 1, wherein the release composition comprises less than 100 ppm of free surfactant.

16. (canceled)

17. The release-coated substrate of claim 1, wherein the substrate is at least 10 micrometers to at most 400 micrometers in thickness.

18. The release-coated substrate of claim 1, wherein the substrate is selected from paper, metal sheet, metal foil, nonwoven fabric, and thermoplastic film.

19. (canceled)

20. (canceled)

21. A release coating composition comprising: a blend of:
(a) a silicone-containing acrylic polymer; and
(b) an acrylate polymer, wherein the acrylate polymer comprises the polymerization reaction product of:
(i) a first monomer having an alkyl group with 12 to 24 carbon atoms, a linking group containing a nitrogen or ester group, and a free-radically polymerizable (meth)acryl group;
(ii) a second free-radically polymerizable monomer having less than 12 carbon atoms; and
(iii) a free-radically polymerizable surfactant.

22. A method for making a release-coated article, the method comprising:
providing a blend, the blend comprising a water borne silicone-containing acrylic polymer;
and a water borne acrylate polymer, wherein the water borne acrylate polymer comprises the polymerization reaction product of:
(i) a first monomer having an alkyl group with 12 to 24 carbon atoms, a linking group containing a nitrogen or ester group, and a free-radically polymerizable (meth)acryl group;
(ii) a second free-radically polymerizable monomer having less than 12 carbon atoms;
(iii) a free-radically polymerizable surfactant; and
(iv) an aqueous carrier liquid;
coating the blend on a substrate; and
removing the aqueous carrier.

23. (canceled)

24. The method of claim 22, wherein the aqueous carrier is removed at web temperatures of at least 20° C. and at most 120° C.
